(19) United States
(12) Patent Application Publication
(10) Pub. No.: US 2004/0155087 A1
(43) Pub. Date: Aug. 12, 2004

(54) Machine for installing rolled shingle roofing material

(76) Inventor: H. Lee Hamlin, Macon, GA (US)

Correspondence Address: Harry I. Leon, 924 Bowen St., N.W., Atlanta, GA, 30318, US

(21) Appl. No.: 10/775,773

(22) Filed: Feb. 9, 2004

Related U.S. Application Data
(60) Provisional application No. 60/446,131, filed on Feb. 10, 2003.

(51) Int. Cl. B25C 5/13

(52) U.S. Cl. 227/110

(57) ABSTRACT

A machine for storing, unrolling, guiding into position and fastening rolled roofing material to a roof deck. The machine includes a holder which cradles the roll of roofing material, or alternately, suspends it on a cantilevered spindle, so that the roofing material can be unrolled and guided into position on the roof deck. A nail gun under automatic control fastens the roofing material at selected intervals to the roof deck. The operator simply moves the machine across the deck and the roofing material is placed and fastened on the roof as quickly he walks. The machine also has a guide bar that follows the edge of the prior row of roofing material for proper placement of the next row. The machine is made n two sections that may be separated for ease of raising to the roof. Further, the machine presented heren can also be powered and controled by electrical energy or by stored pressured gas.

A provisional application No. 60/446,131 was filed on Feb. 10, 2003 and request is being made for priority under Title 35, United States Code #119(e).

### BACKGROUND OF THE INVENTION

The Inventor, a roofing contractor, has done previous work developing rolled roofing material, U.S. Pat. Nos. 6,374,568 and 5,996,300 which were entitled: ROLLED SHINGLE ROOFING MATERIAL AND METHOD OF INSTALLATION. The inventor has found that the use of rolled shingle material allows for a labor saving method to install the roof. The rolled roofing material as also found by the inventor as a means to allow for a wide variation of decorative designs and has several patents pending on different roofing decorative designs. Although, all the above rolled roofing material may be manually installed it would be time and cost saving if the installation of this roofing material could done by the use of a machine.

### SUMMARY OF THE INVENTION

The object of this invention is to provide a machine in which rolled shingle roofing material can be easily carried, positioned and fastened to a roof deck. The machine comprises a wheeled frame that has a handle for the user to guide the machine, a holder for the rolled roofing material supported by the frame attached to the frame, a guide for positioning the roofing material as it is being unrolled onto the roof deck, and an automatic nailing sequence. This machine allows a strip of the roofing material to be installed as quickly as the user can walk across the roof deck. The machine is most suited for roofs that have a less than a 30 degree slope or a 7/12 pitch.

The machine is comprised of two basic sections: the first section holds the rolled roofing material, allows the material to be unrolled and guides it to proper position on the roof deck. The second section has automatic nailing apparatus with controls that allows the nails to be interval-placed at predetermined locations on the shingle.

The stored roofing material is held by a series of spaced apart rollers that form an arc of a circle. The rolled roofing is simply placed on top of these roller that cradle the rolled roofing material and the front end the roofing material is threaded through the rollers.

An alternate method of holding the stored rolled roofing material is a cantilever shaft that allows the center of the rolled material to be placed on this shaft. The shaft is supported by bearings that allow the shaft to rotate as the roofing material is discharged. The nailing section can use a standard pneumatic nailing gun or one modified for this machine. When a standard nailing gun is used, the handle is supported by the frame and a small pneumatic cylinder is used to lower the gun and press the barrel on the roof deck. The trigger of the gun may be fastened in the activation position or for extra safety activated by a solenoid or equivalent that will pull the trigger. When the gun is lowered to the roof by the pneumatic cylinder this automatically releases the nail penetrating the roofing material and into the roof deck.

The interval for nailing or spacing is controlled by a light source switch that senses the slots in shingles as it is rolled on to the roof deck. The light source switch activates a solenoid valve that allows the compressed air to enter the pneumatic cylinder and the nailing gun.

An alternate interval control means comprises a control wheel that rotates as the user pushes or pull the machine across the roof deck. The control wheel has one or more cams mounted on the rim of the wheel which activates a cam-operated poppet valve that controls air to a nail gun. The nailing operation with both designs can also be manually controlled by a hand operated poppet valve mounted on or near the handle of the machine. Manual operation is often needed at the start and end of a row of roofing material as it is installed on the roof deck.

### BRIEF DESCRIPTION OF THE DRAWINGS

FIG. 1 is a top right side perspective view of the machine showing a roll of roofing material installed in the machine and machine moving along a roof as the shingles are being nailed;

FIG. 2 is a top left side perspective view of the machine showing a roll of roofing material installed in the machine and machine moving along a roof as the shingles are being nailed;

FIG. 3 is a front perspective of the machine;

FIG. 4 is a rear perspective of the machine;

FIG. 5 is s view showing the rear part of the machine in the hinged raised position;

FIG. 6 is a closeup of the nail gun and its control cylinder in the machine according to FIG. 1;

FIG. 7 is a closeup of the sequence control mechanism for the nail gun in the machine according to FIG. 1;

FIG. 8 is a view of a fragmentary portion of an alternate embodiment of the machine according to the present invention having a spindle for holding the roll of roofing material as it is being unrolled;

FIG. 9 is a schematic of the control operation of the machine according to FIG. 1; and

FIG. 10 is a schematic of the control operation of a further alternate embodiment of the machine.

### DESCRIPTION OF THE PREFERRED EMBODIMENT

In accordance with the present invention, a machine for installing rolled roofing material 50 comprises a wheeled frame, a holder 11, a guide roller 12 for directing the roofing material from the holder to the surface of a roof deck, and means, including a nailing gun 26, for fastening the roofing material to the deck. In the drawings, the machine is indicated generally by the reference numeral 10.

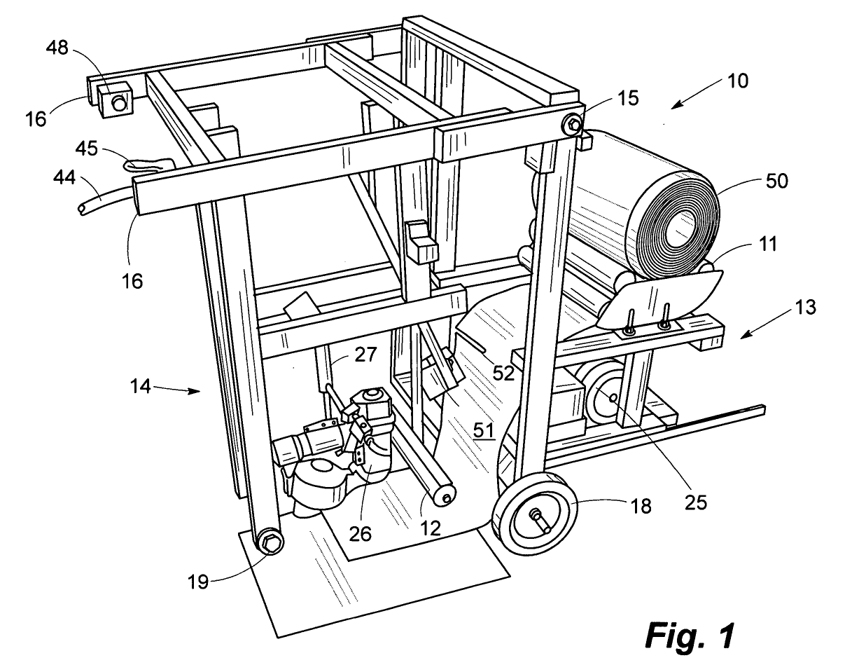

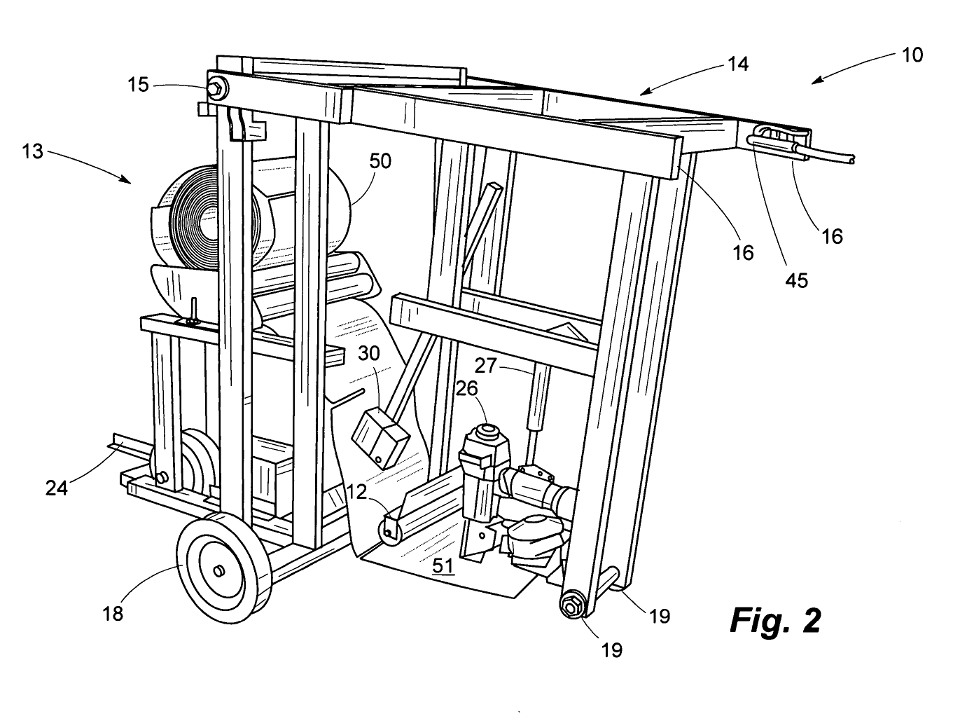

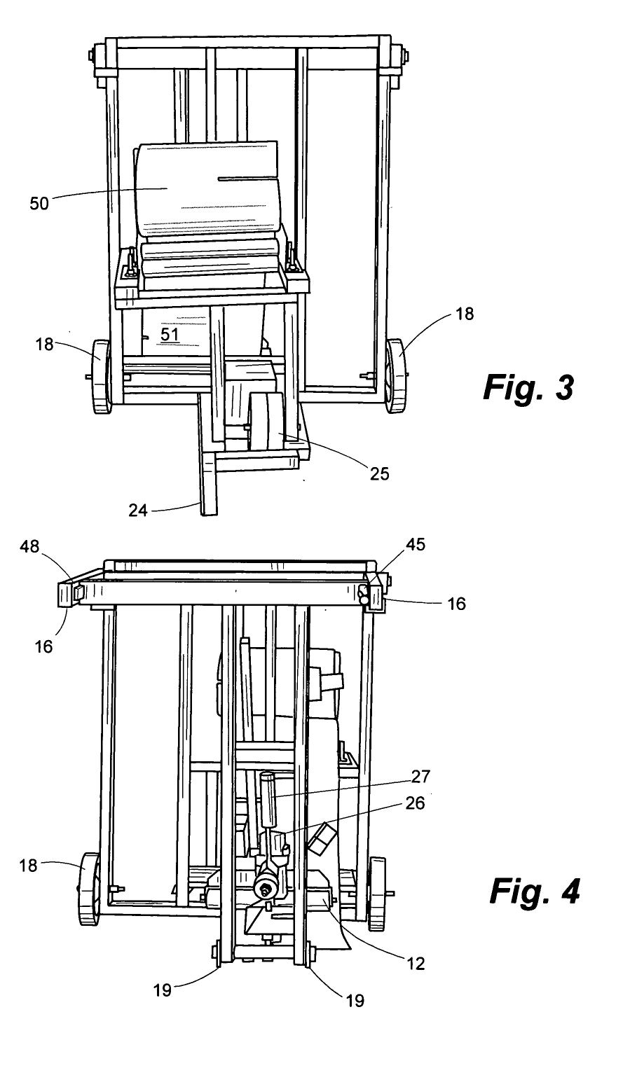

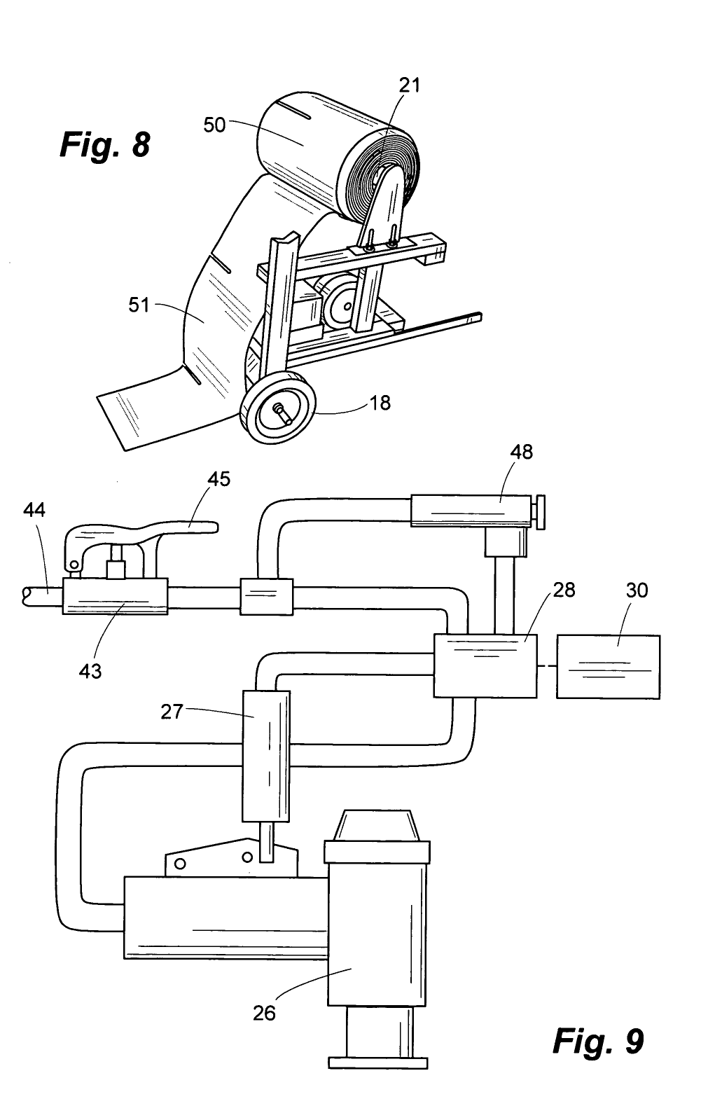

Preferably, the holder comprises a plurality of rollers 11 which are rotatably mounted within the wheeled frame in such a way as to form a cradle for the roll of roofing material 50 (FIG. 1). Alternately, the rolled roofing material 50 is held on a horizontally disposed spindle 21 which penetrates the center of the roofing material roll (FIG. 8) The nailing gun 26 is lowered onto the unrolled roofing material 51 downstream of the guide roller 12 by the activation of a pneumatic cylinder 27 (FIGS. 1 and 2). For safety, a hand-operative poppet valve 43 mounted on or near a portion of the wheeled frame which defines a handle 16 must be activated to allow compressed air to the pneumatic cylinder 27 to flow from a supply hose 44 via control valve 28 when the control valve 43 handle 45 is pressed (FIG. 1).

A sequence of automatic nail gun operation is set into motion by a light switch 30, powered by a battery 23 and having a light beam which is reflected by a mirror 31 (FIG. 7) when a slot 52 in the moving shingle material 51 passes under the light beam. The light switch 30 activates the control valve 28 which in use, is fluidly connected to the pneumatic cylinder 27. The roof deck itself triggers the nail gun 26, once it has been lowered to the roof deck by the pneumatic cylinder 27.

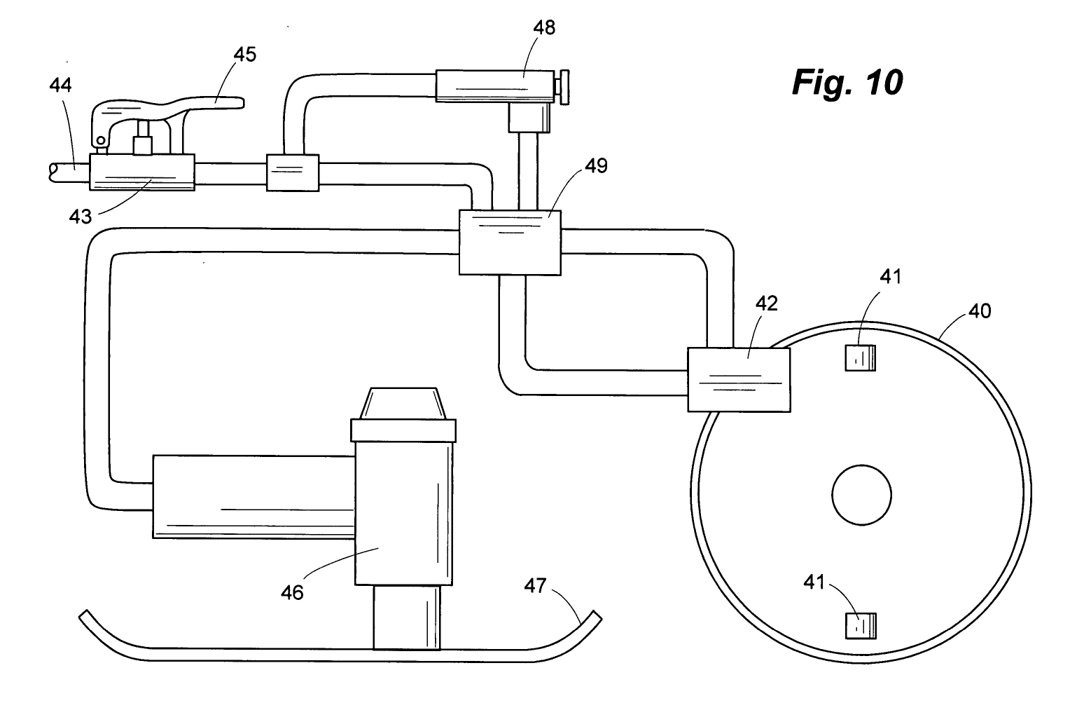

Alternately, the automatic nailing operation is regulated with the use of a control wheel 40 (FIG. 10). The control wheel 40 replaces on of the wheel 18 or 25 supporting the frame and has cam 41 mounted on the inside rim of this wheel that active a cam-operated poppet valve 42. This control mechanism allows a nail gun 46 to ride a sled 47 above the top surface of the new roofing material and controlled by the valve 42 (FIG. 10). Other control elements for this nailing operation include a control pilot valve 49 which sends compressed air flow to the nailing gun 46 when the safety valve's 43 handle 45 is pressed along with the cam-operated poppet valve 42, yielding interval nailing synchronous with the rotation of the control wheel 40.

For safety, a hand-operated poppet valve 43 having control handle 45 is mounted on the handle 16 and allows air flow from the supply hose 44 to control valve 49 only while the valve's handle is held.

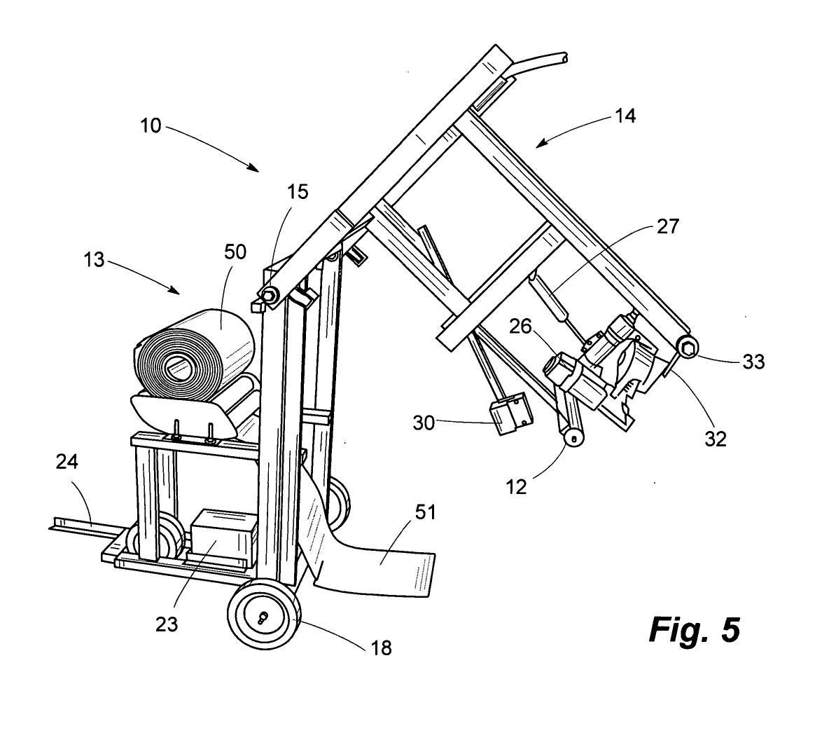

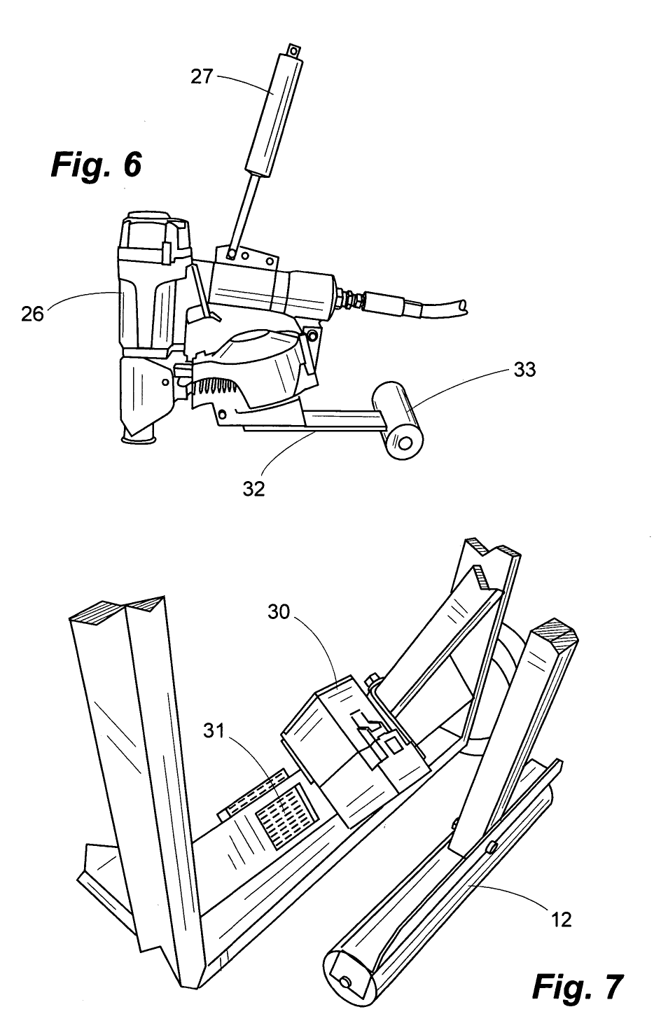

In the preferred embodiment, the wheeled frame of the machine is made in two sections, the material storage section 13 and the control and nailing section 14. These sections are pivotally connected by a hinge 15 (FIG. 5). For ease raising to the roof the hinge 15 can be disconnected and the sections 13, 14 lifted independently. The sections are equipped with wheels 18, 25 and pivot rollers 19 for ease of movement along the roof deck. As the machine sits on the roof deck the pivot rollers 19 are slightly above the roof deck; when the operator pushes the handles 16 downward this raises the wheel 25 off the deck and allows the pivot rollers 19 to come into contact with the roof deck; a sidewise push then allows the machine 10 to rotate sidewise about the point of contact of rollers 19 or the wheels 18 on the roof deck.

The machine 10 also includes a guide bar 24 for positioning the machine relative to the next strip of roofing material to be placed a roof deck. As the user pushes the machine 10 across he roof deck, the guide 24 bar rides in the edge of the previously laid row of roofing material and the next row of material can then be put into place as quickly as the user can walk across the roof deck.

The nailing operation for both design can also be manually controlled by a hand-operated poppet valve 48 placed on or near the handle 16. Even for manual operation the safety value handle 45 needs to be pressed simultaneously with manual valve 48.

It is understood that the nailing gun and its controls described above may also use any combination of electrical or gas driven equipment instead of pneumatic power.

It is understood that those skilled in the art may conceive other applications, modifications and/or changes in the invention described above. Any such applications, modifications or changes which fall within the purview of the description are intended to be illustrative and not intended to be limitative. The scope of the invention is limited only by the scope of the claims appended hereto.

It is claimed:

1. A machine for installing rolled shingle roofing material on a roof deck comprising:
(a) a wheeled frame;
(b) a holder for the rolled roofing material from which roofing material can be unroll, the holder being mounted on the frame;
(c) a guide roller connected to the frame which directs the roofing material from the holder to the roof deck surface; and
(d) means for fastening the roofing material to the roof deck.

2. The machine according to claim 1, wherein the means for fastening the roof material to the roof deck comprises a pneumatic nailing gun and a pneumatic cylinder, the gun being activated by the pneumatic cylinder when the pneumatic cylinder presses the head of the nailing gun to the roof deck.

3. The machine according to claim 2, which further comprises a light switch which activates the pneumatic cylinder only when a light beam detectable by the switch penetrates a slot opening in a shingle-type rolled roofing material.

4. A machine according to claim 2, which further comprises a hand operated safety valve that must be held before the nail gun can be operated.

5. A machine to facilitate installation of rolled shingle roofing material on a roof deck comprising:
(a) a frame which has a plurality of wheels, one of the wheel having at least one cam attached thereon;
(b) a holder for the rolled roofing material from which roofing material can be unrolled; the holder being mounted on the frame;
(c) a guide roller connected to the frame which directs the roofing material from the holder to the roof deck surface; and
(d a means for fastening the roofing material to the roof deck, the fastening means comprising a pneumatic nailing gun and a cam-operated pneumatic valve which is activated by the cam on said wheel, the pneumatic nailing gun being controlled by the pneumatic valve.

6. The machine according to claim 5, which further comprises a hand operated safety valve which must be activated before nailing gun can be operated.
